(19) United States
(12) Patent Application Publication
(10) Pub. No.: US 2021/0390629 A1
(43) Pub. Date: Dec. 16, 2021

(54) EXPENSE FRAUD DETECTION

(71) Applicant: Amadeus S.A.S., Biot (FR)

(72) Inventors: Sebastian Bildner, Munich (DE); Paul Krion, Munich (DE); Thomas Stark, Munich (DE); Martin Stammler, Munich (DE); Martin Von Schledorn, Munich (DE); Jürgen Oesterle, Munich (DE); Renjith Karimattathil Sasidharan, Bangalore (IN)

(21) Appl. No.: 16/902,960

(22) Filed: Jun. 16, 2020

(51) Int. Cl. G06Q 40/00; G06N 20/00; G06K 9/00

(52) U.S. Cl. CPC G06Q 40/125; G06K 9/00449; G06K 9/00469; G06N 20/00

(57) ABSTRACT

Methods and systems of assessing data inputs to detect and judge erroneous or fraudulent data inputs is provides. A machine learning system is based on training data to develop a model to assess future data inputs. The training data are based on historical data inputs. Based on the results of the assessment of the future data inputs, a set of predefined actions may be triggered in order to handle the erroneous or fraudulent data inputs.

### TECHNICAL FIELD

The present invention relates to database technology and data handling in a distributed computer environment.

### BACKGROUND

One object in data base systems is to maintain data integrity. Data entries should fulfill rules of accuracy and consistency, which are dependent on the applicational field, in which the corresponding data are generated. Inaccurate and inconsistent data can arise, e.g., from erroneous input and miscalculations, but also from fraudulent input and data manipulation. Detecting fraudulent data input and manipulation can be challenging, particularly in environments dealing with data, whose nature makes it difficult to determine whether data manipulation has arisen from a fraudulent behavior of the inputting user or from erroneous input. An example for fraudulent data manipulation is the manipulation of pictures, such as photographs, which may then be spread over the Internet. Another example are frauds stemming from employees of big corporations and organizations when they submit their business trip expenses for reimbursement, such as handing in expenses for private purposes as part of expenses which have occurred on a business trip.

Detecting fraudulent data input and manipulation, for example in the field of corporate travel expense accounting, usually requires an individual check of every invoice by a person. This person judges whether the invoice might be fraudulent or erroneous according to its experience which is based on the checking of past invoices. Although this method provides a rather effective approach in order to detect erroneous and even fraudulent travel invoices, this method consumes many resources with regard to working time and involved personnel, especially in large corporations and organizations.

Therefore, it would be desirable to provide a method for detecting erroneous and fraudulent data input for large data systems which requires only a limited amount of resources.

### SUMMARY

In a first aspect of the invention, a computer-implemented fraud detection method in a distributed computing environment is provided. The method comprises a machine learning activity and a fraud detection activity. The machine learning activity comprises receiving training data entries and receiving classification data and defining a plurality of classification criteria based on the classification data. The machine learning activity further comprises classifying the training data entries according to a first subset of classification criteria and thereby obtaining classified training data entries, grouping the classified training data entries into training data tuples according to a second subset of classification criteria, grouping training data tuples into a set of training data, applying a machine learning algorithm to the set of training data to obtain a model based on the set of training data and storing the set of training data and/or the model in one or more databases. The fraud detection activity comprises receiving additional data entries obtained from one or more documents and classifying the additional data entries according to a first subset of classification criteria, thereby obtaining additional classified data entries. The fraud detection activity further comprises grouping the additional classified data entries into additional data tuples according to a second subset of classification criteria, comparing the additional data tuple with the model obtained by the machine learning activity, thereby determining a set of values indicating the results of the comparison, evaluating the set of values indicating the results of the comparison relative to at least one fraud detection rule, wherein different levels of violation of the fraud detection rule are associated with different corresponding predefined actions, and executing the respective predefined action according to the level of fraud detection rule violation, wherein the predefined action comprises displaying a symbol on a computer screen indicating the level of fraud detection rule violation.

According to a second aspect of the invention, a fraud detection system within a distributed computer environment is provided, which comprises at least one computing system comprising a machine learning module and a fraud detection module and at least one database connected to the at least one computing system. The machine learning module is configured to receive training data entries, receive classification data and define a plurality of classification criteria based on the classification data, classify the training data entries according to a first subset of classification criteria to obtain classified training data entries, group the classified training data entries into training data tuples according to a second subset of classification criteria, group training data tuples into a set of training data, apply a machine learning algorithm to the set of training data to obtain a model based on the set of training data, and store the set of training data and/or the model in one or more databases. The fraud detection module is configured to receive additional data entries obtained from one or more documents, classify the additional data entries according to a first subset of classification criteria to obtain additional classified data entries, group the additional classified data entries into additional data tuples according to a second subset of classification criteria, compare the additional data tuple with the model obtained by the machine learning activity to determine a set of values indicating the results of the comparison, evaluate the set of values indicating the results of the comparison relative to at least one fraud detection rule, wherein different levels of violation of the fraud detection rule are associated with different corresponding predefined actions, and execute the respective predefined action according to the level of fraud detection rule violation, wherein the predefined action comprises displaying a symbol on a computer screen indicating the level of fraud detection rule violation.

According to a third aspect of the invention, a non-transitory computer-readable medium which causes a computer to execute a machine learning activity and a fraud detection activity is provided. The machine learning activity comprises receiving training data entries and receiving classification data and defining a plurality of classification criteria based on the classification data. The machine learning activity further comprises classifying the training data entries according to a first subset of classification criteria and thereby obtaining classified training data entries, grouping the classified training data entries into training data tuples according to a second subset of classification criteria, grouping training data tuples into a set of training data, applying a machine learning algorithm to the set of training data to obtain a model based on the set of training data and storing the set of training data and/or the model in one or more databases. The fraud detection activity comprises receiving additional data entries obtained from one or more documents and classifying the additional data entries according to a first subset of classification criteria, thereby obtaining additional classified data entries. The fraud detection activity further comprises grouping the additional classified data entries into additional data tuples according to a second subset of classification criteria, comparing the additional data tuple with the model obtained by the machine learning activity, thereby determining a set of values indicating the results of the comparison, evaluating the set of values indicating the results of the comparison relative to at least one fraud detection rule, wherein different levels of violation of the fraud detection rule are associated with different corresponding predefined actions, and executing the respective predefined action according to the level of fraud detection rule violation, wherein the predefined action comprises displaying a symbol on a computer screen indicating the level of fraud detection rule violation.

The above summary may present a simplified overview of some embodiments of the invention in order to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE FIGURES

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is schematic depiction of a distributed computer environment as described herein.

FIG. 2 shows a flow diagram of an example method for handling data in a distributed computer environment.

FIG. 3 shows a flow diagram presenting the activities for processing the data training entries according to the example method.

FIG. 4 illustrates the initial activities of the example method.

FIG. 5 shows the formation of a data tuple according to an example.

FIG. 6 shows the relation of various data tuples to certain business travels according to an example.

FIG. 7 shows the grouping of data tuples into a set of training data according to an example.

FIG. 8 illustrates the application of a machine learning algorithm on a set of training data according to an example.

FIG. 9 shows the processing of the additional data and the detection of fraud according to an example.

FIG. 10 shows probabilities that a fraud has occurred and predefined actions based on that probabilities according to an example.

FIG. 11 shows illustrates the application of a machine learning algorithm on a set of feedback data according to an example.

FIG. 12 is a diagrammatic representation of the internal components of a computing machine according to an example.

### DETAILED DESCRIPTION

Contemporary decision making, e.g., in big corporations and organizations and almost on all organizational levels, relies on respective data. In order to make proper decisions, these data have to be correct and trustworthy. In the case of travel expenses, for example, the decision to reimburse travel expenses to an employee by the corresponding department requires a well based assumption that the bills and invoices the employee has handed over to the travel department are correct, i.e., that the documents do not contain any errors and fraudulent manipulations. This may be done by using specially trained and experienced employees, who normally review each of the bills and invoices handed in by the corresponding employees and, based on their experience and training, assess the validity of each bill and invoice.

When performing business trips, each employee typically creates costs within a certain range, resulting from the destinations and the length of the business trips, the types of hotels the employee stays overnight, the types of meals the employee consumes etc. These costs normally vary only within a certain rage. Acceptable and legally explainable exceptions can occur, e.g., an overseas business trip or a lengthy business trip. However, higher travel expenses can also occur due to fraudulently handing in invoices, which e.g., cover costs for explicitly private purposes. It has, however, to be kept in mind that the nature of business trips for a single employee can change, e.g., when the employee has got an upgrade, which may result in that the employee now meets with high ranking executives of other companies. Therefore, the costs for hotels and meals may increase, which would in absolute agreement with the guidelines of the corporation or organization.

The travel departments are trained to recognize erroneous and fraudulent handing-ins of invoices and the travel departments are also informed when e.g., an employee has got an upgrade and is now entitled to higher travel expenses. This requires competent staff in the travel department, whose training has always to be up-to-date, and, when the corporation is a big corporation, also numerous members of that staff are required. All this requires the allocation of human resources, costs etc. from the corporation.

Therefore, a method and a system which automatically asses the validity of travel expenses handed in by the employees, but which is also flexible enough to assess legal changes in travel expenses (e.g., when the employee has received a status upgrade) is desirable. The automated system should also allow the deployment in a distributed corporate environment, so that an employee is able to hand in a travel expense at any location and the processing of the travel expense can occur at a central location designated by the corporation.

The method and the system should be able to know for each employee in a corporation or organization the typical amount of expenses for a business trip, which may depend on the field of activity and the status of the employee. This “knowledge” of the system is derived from a set of training data which is obtained by scanned documents and which is composed of the expenses of earlier business trips of the respective employee. When the employee hands in the bills and invoices for a new business trip, the system is then capable to assess whether the expenses claimed by the employee are erroneous and/or even fraudulent. The new data also forms a new data set for the training data, and a self-learning algorithm, which is applied over the training data, may calculate new values for the typical travel expenses the employee normally causes. The self-learning algorithm includes in its processing additional information such as promotions of the employee and changes in the fields of activity. In some embodiments, the self-learning algorithm also keeps track of any attempts of fraud or erroneous inputs of the employee in order to recommend or apply e.g., stricter rules for auditing with respect to the corresponding employee. Such a method and system may be referred to as fraud detection (or: fraud estimation) method and system, respectively.

The self-learning algorithm may use, in some embodiments, additional data input for the calculation of the typical travel expenses which may not be provided by the employee itself but e.g., from a corporate administrator. The additional data input may comprise information such as the change of the field of activity of the employee, the change of the location of activity of the employee, various promotions etc., which may result in increased expenses for various travels.

The self-learning algorithm or machine learning algorithm can be realized by various systems, such as artificial neural networks, support vector machines, Bayesian networks and genetic algorithms using approaches such as supervised, semi-supervised or unsupervised learning, or approaches such as reinforcement learning, feature learning, spare dictionary learning etc.

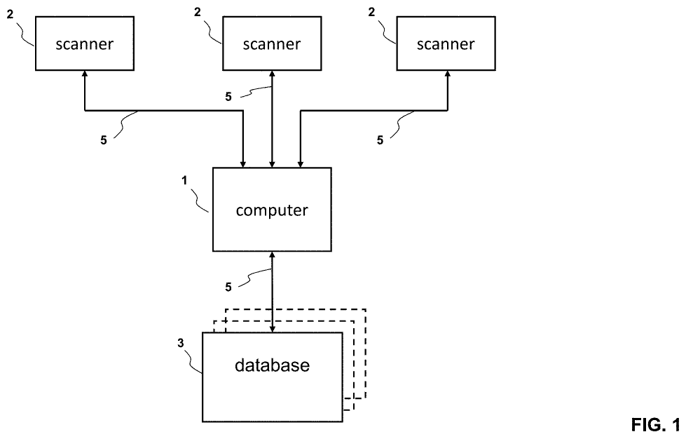

FIG. 1 shows a distributed computing system according to an embodiment. The computing systems comprises of a computer 1, scanning devices 2 and databases 3.

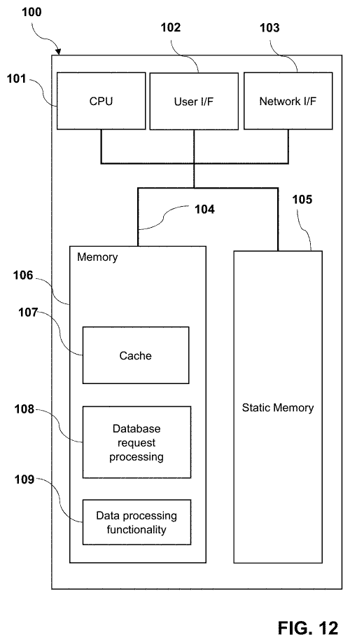

The computer 1 may be constituted of one or several hardware machines depending on performance requirements. The computer 1 is embodied e.g. as stationary or mobile hardware machines comprising computing machines 100 as illustrated in FIG. 12 and/or as specialized systems such as embedded systems arranged for a particular technical purpose, and/or as software components running on a general or specialized computing hardware machine (such as a web server and web clients).

The scanning devices 2 are embodied e.g., as hardware components for scanning in paper-based documents and/or as hardware components for taking a photographic image of paper-based documents, such as mobile devices with integrated cameras (e.g., smartphones or the like). The scanned images taken from the paper-based documents are converted into a computer-readable format using techniques such as Optical Character Recognition (OCR). The conversion can be performed e. g at the scanning devices 2 or at the computer 1. In some embodiments, the scanning devices 2 may form part of the computer 1. Photographic images of the paper-based documents taken from mobile devices are e.g., in formats like JPEG or RAW, or the like.

The computer 1 is connected to a database 3. In some embodiments, the database 3 may be formed as a relational SQL (Structured Query Language) database. In some further embodiments, the database 3 may form part of the computer 1.

The computer 1, the scanning devices 2 and the databases 3 are interconnected by the communication interfaces 5. Each of the communication interfaces 5 utilizes a wired or wireless Local Area Network (LAN) or a wireline or wireless Metropolitan Area Network (MAN) or a wireline or wireless Wide Area Network (WAN) such as the Internet or a combination of the aforementioned network technologies and are implemented by any suitable communication and network protocols.

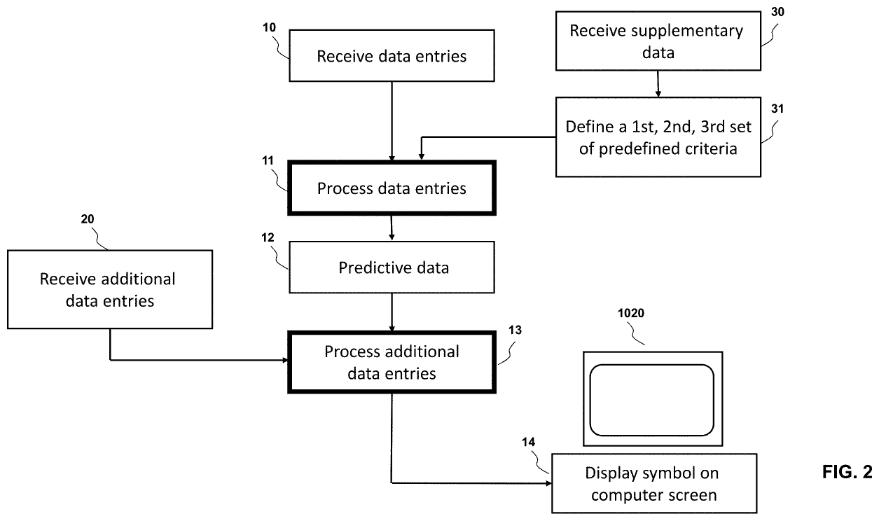

A flow diagram for an example method according to some embodiments is presented in FIG. 2. A detailed description of the activities shown in FIG. 2 is given in the subsequent paragraphs. In an activity 10, data entries are received by computer 1. These data entries may be in a format suitable for further processing by the subsequent parts of the method. In a processing activity 11, the data entries are processed by computer 1 to form a set of training data. These training data are used to develop a model which can be for the assessment of e.g., the validity and accuracy of employee's travel invoices. The method of formation of the set of training data comprises a machine learning activity using e.g., self-learning algorithms at computer 1. The processing activity 11 may require further input for the developing of the model such as for the classification of the data entries. Therefore, in an activity 30 supplementary data are received and based on these supplementary data which are described in the subsequent paragraphs, a plurality of classification criteria may be defined in an activity 31 which is used in developing the model.

Once the model has been developed, a set of predictive data is defined in an activity 12. These predictive data may be used to assess the validity of e.g., the travel expenses of a specific (e.g., recent) trip of an employee. As an example, the predictive data may comprise average travel expenses, which should be expected for each employee of a corporation. The travel expenses of a specific trip are received in an activity 20 as additional data entries and processed together with the predictive data in an activity 13, where a result of the assessment of the employee's travel expenses is obtained. This result may in an activity 14 trigger the execution of a predefined action according to the level of fraud detection rule violation, wherein the predefined action comprises displaying a symbol on a computer screen 1020, as shown in FIG. 2, indicating the level of fraud detection rule violation. The symbol may be a traffic light symbol on the computer screen 1020, such as a red traffic light or any either traffic related road sign, which are related to warning or danger, such as a stop sign. The predefined action may also comprise a warn tone produced by a speaker of the computer 1, such as a bell or a warning beep.

In some embodiments, the computer 1 may comprise of a system of distributed computing entities such as servers, wherein the machine learning system may operate at one computing activity. In some embodiments, at the computer 1, training data entries obtained from one or more documents scanned from a device for scanning documents are received. In some further embodiments, wherein the computer 1 comprises of a system of distributed computing entities, the individual distributed computing entities receive the training data entries and sent them to the computing entity hosting the system for the machine learning activity.

In further embodiments, the documents are paper-based documents. The scanning devices for scanning documents are, in further embodiments, comprised in the distributed computing environment. After scanning of the paper-based document with e.g., a scanner or a camera integrated in a mobile phone, the scanned characters are converted into an electronically processable data structure. This can be performed by e.g., OCR conversion of a scanned paper document such as e. g an invoice for overnight stays in a hotel, which may form part of a collection of expenses for a business travel for an employee.

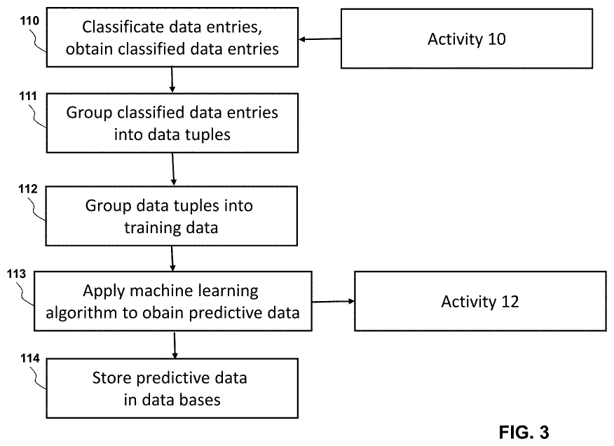

The processing activity 11 of the example method is shown in more detail in FIG. 3 and described closer in the subsequent sections. As aforementioned, the processing activity 11 of the received data entries may be carried out using the plurality of sets of classification criteria, which may get defined in activity 31. The classification criteria may be defined based on received supplementary data, which may comprise the classification data. In some embodiments, the supplementary data may be received by a different activity that the scanning of a paper-based document. The supplementary data may be entered by an administrator entrusted with the task of formulating and defining the set of criteria according which the received data entries are processed. These supplementary data may comprise classification criteria such as e.g., amount (to be paid), date (of invoice), country (of invoice), expense type etc. In some other embodiment, the classification data are obtained using the training data entries. In some further embodiment the classification data are obtained using the machine learning algorithm with the training data entries as input data.

The flow diagram of FIG. 3 further illustrates the processing activity 11 for processing the data training entries at the computer 1 according to the example method. The computer 1 or one or more of its computing entities classifies 110 the training data entries according to a first subset of classification criteria, which may be taken from the sets of classification criteria, thereby obtaining classified training data entries. In some embodiments, the first subset of classification criteria contains classifications related to expense invoices, in particular travel expense invoices, such as “total invoice amount”, “invoice date”, “type of invoice”, “location of invoice”, “gross amounts”, “net amounts”, “tax rates”, but also e.g., “invoice number”, “specific amount to be paid”, “VAT”, etc: These classified training data entries may be, in some embodiment, in a key-value data format. An example for such a classified data entry in a key-value data format taken from the domain of business travel may be <amount to be paid (of hotel costs), 1000 $>. In a subsequent activity 111 at the computer 1, the classified training data entries are grouped into training data tuples according to a second subset of classification criteria, which also may be taken form the sets of classification criteria. In some embodiments, the second subset of classification criteria comprises criteria related to corporate data, in particular corporate personal and/or project data, such as the name of the employee, the corporate ID-number of the employee, the country of residence of the employee, travel destination country or the corporate departments or projects—especially their project names, project numbers or project titles—the employee is assigned to. In further embodiments, there could be also other fields the second subset is related to. For the sake of simplicity, these relation to other fields should be summarized in the criteria “file number”. The second subset of criteria may also contain classifications relating to the overall nature of a particular bill, such as “invoice for hotel”, “invoice for dinner”, “invoice for a rental car”, “invoice for fuel at a gas station”. In some further embodiment, a number is attached to the various invoices, such as “invoice number 1”. This number can be combined with a certain business travel of the employee such as “invoice number 1. business travel number 1, employee John Doe”. Also, the total number of invoices can be comprised. Such a tuple may then read as follows.

<employee-ID, 999999>;
<employee name, John Doe>,
<business travel number, 123>;
<travel destination country, USA>,
<city of destination, New York>,
<hotel name, Excelsior>,
<number of days, 5>;
<amount of hotel costs, 1000 $>;
etc.

In some further embodiments, the classified data entries and/or the classified training data entries are arranged as input vectors and/or feature vectors, whereby the features may be in a purely numeric format.

The training data tuples are then grouped in an activity 112 into a set of training data. To cite the aforementioned example, the set of training data may comprise of the entirety of the travel expenses an employee of a corporation has handed in so far. In an activity 113, the computer 1 applies a machine learning algorithm to the set of training data to obtain a model based on the set of training data. Such a model may comprise predictive data such as average travel expenses, which should be expected for each employee of a corporation. The model could also yield information, which type of costs a specific employee typically creates or does not create, e.g., the model yields the information that employee John Doe does not use airplanes during its business trip, since he performs such trips only in the same city he is performing his business duties. In some embodiments, the predictive data is stored in an activity 114 in a database.

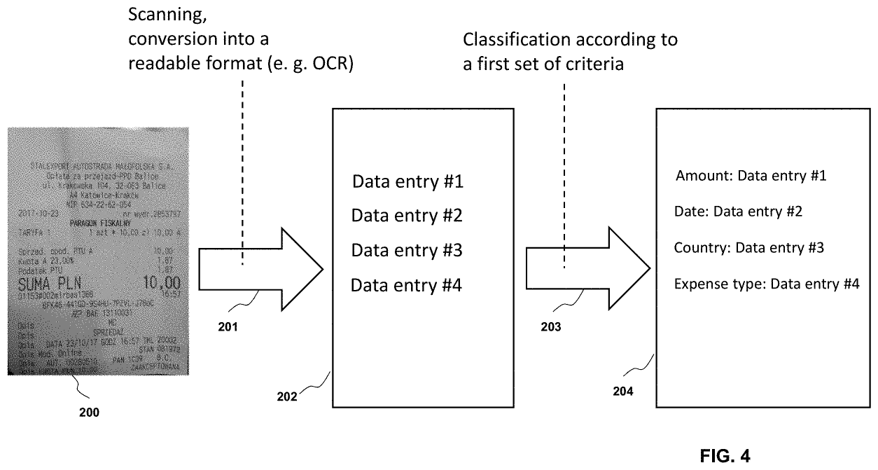

The initial activities of the example method discussed so far are illustrated in FIG. 4. A paper-based invoice 200, e.g., a bill for gasoline tanked at a gas station, is scanned in at some scanning device 2, e.g., a camera equipped smart phone. The scanned document is then converted by a conversion 201 into a readable format, e.g., using an OCR-software. In some further embodiments, the conversion 201 is carried out at the scanning device 2. In some further embodiments, the conversion 201 is carried out at the computer 1. In some further embodiments, the computer 1 may form a distributed computing system comprising of various computing entities, wherein the conversion 201 is carried out at a different computing entity than the machine learning activity. The conversion 201 yielded in a set of training entries 202, which will be in subsequent activity subjected to a classification 203 according to the first set of criteria to obtain classified data entries 204, e. g the amount for the gasoline tanked at the gas station, which may be denoted in the key-value format as <amount: 10 €>.

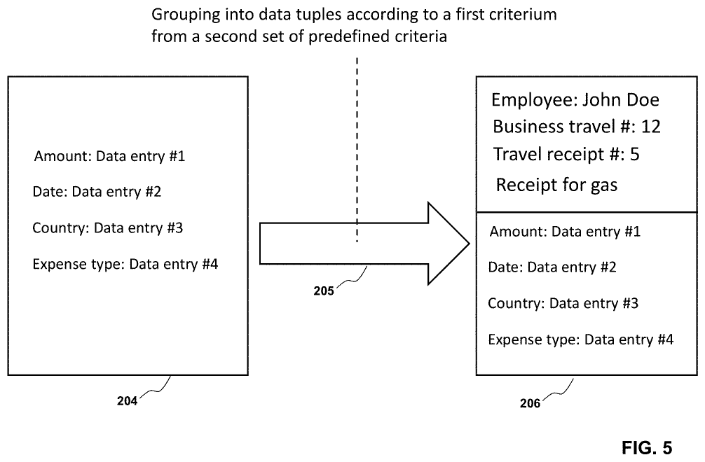

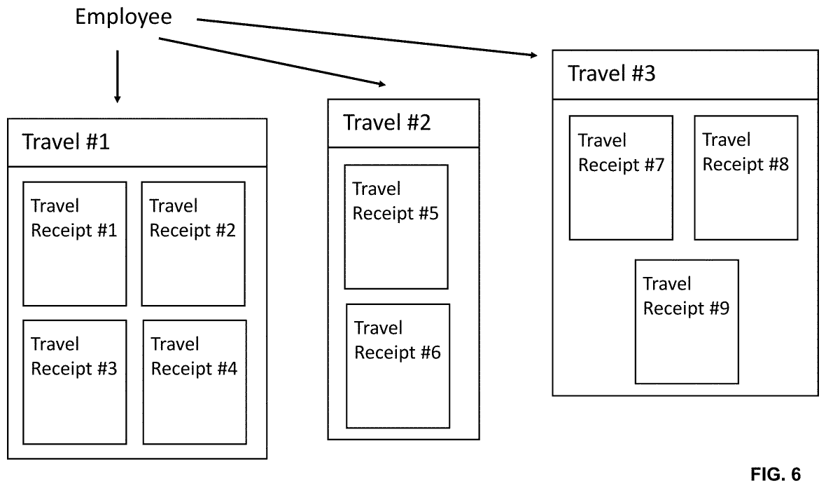

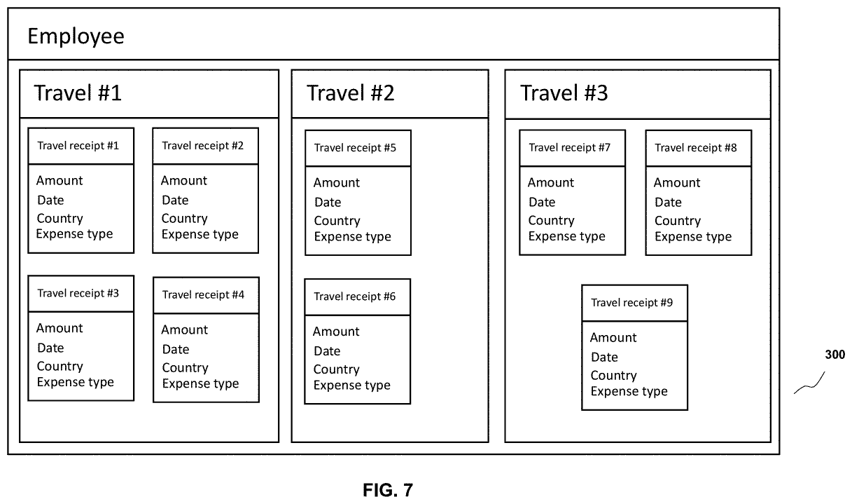

Referring to FIG. 5, the formation of a data tuple is illustrated. The classified data entries 204, which e.g., represent the data of the paper-based invoice 200, are grouped in an activity 205 into a data tuple 206, representing, as an example, the invoice caused by employee John Doe for fuel for the rental car, whereby the invoice has been awarded the number “5” and the business travel the number “12”. In some embodiment, the various data tuples are therefore related to a certain business ravel of a certain employee, as schematically illustrated in FIG. 6. The entirety of data tuples 206 are grouped into a set of training data 300 as shown in FIG. 7, which in the context of the aforementioned example represents all the invoices an employee has created during his/her business travels so far.

Referring back to FIG. 3, computer 1 applies in an activity 113 a machine learning algorithm to the set of training data to obtain a model based on the set of training data. In some embodiment, the model describes the usual costs an employee creates during his/her business trips in the form of predictive data, as defined in activity 12 (cf. FIG. 2). The usual costs can comprise e.g., the average costs for hotels, meals, flights, rental cars etc. In some embodiment, computer 1 stores the set of training data and/or the model such as the predictive data in one or more of the databases.

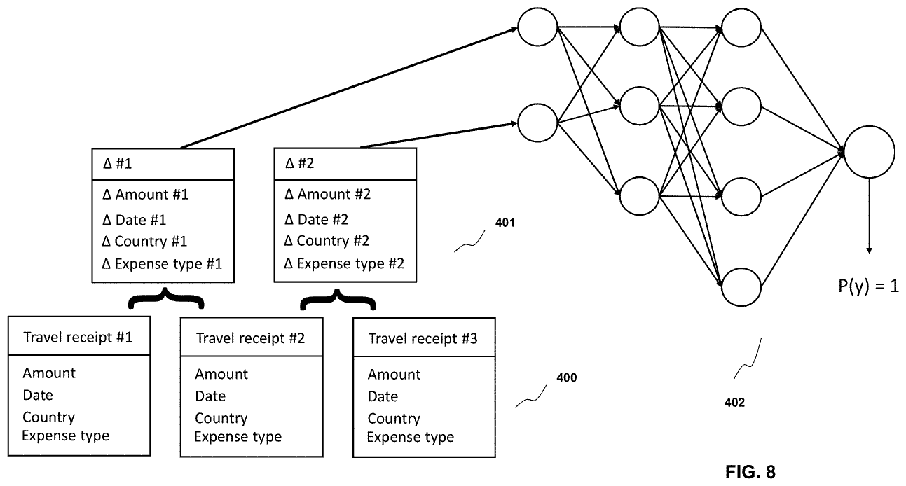

In FIG. 8, a machine learning system 402 applied by computer 1 on the set of training data 300 is illustrated according to some embodiment. Differences between corresponding classified training data entries of a first training data tuple and a second training data tuple are calculated and said differences are added to the set of training data. From corresponding invoices 400, such as hotel invoices, all differences 401 between two amounts, which have been paid, may be calculated. These set of differences may also be added as part of the training data for the machine learning system 402. In some embodiments, the machine learning system 402 applies as a deep learning method a method based on an artificial neural network using multiple hidden layers, which is exemplarily shown in FIG. 8. The resulting probability P(ŷ=1) tells how likely the additional data entries provided by the employee are valid for the corresponding business travel.

In some embodiments, the machine learning algorithm applied by the machine learning system 402 is based on learning algorithms which may comprise of supervised learning, semi-supervised learning, unsupervised learning, reinforcement learning, feature learning, sparse dictionary learning, anomaly detection, decision tree learning, association rule learning, etc. In some further embodiment, the machine learning algorithm applied by the machine learning system 402 is based on support vector machines, Bayesian networks, genetic algorithms etc.

As aforementioned, the predictive data defined in activity 12 (cf. FIG. 2) forms one of the input values for the process of assessing additional travel expenses handed in by the employee. These additional travel expenses can be the expenses of the most recent business trip of the employee. The fraud detection activity, performed at computer 1, comprises in activity 20 the reception of additional data entries obtained from one or more documents scanned from a device for scanning documents wherein the additional data entries are extracted from the scanned documents by optical character recognition (OCR) techniques. The additional data entries are further processed together with the predictive data in activity 13 by computer 1.

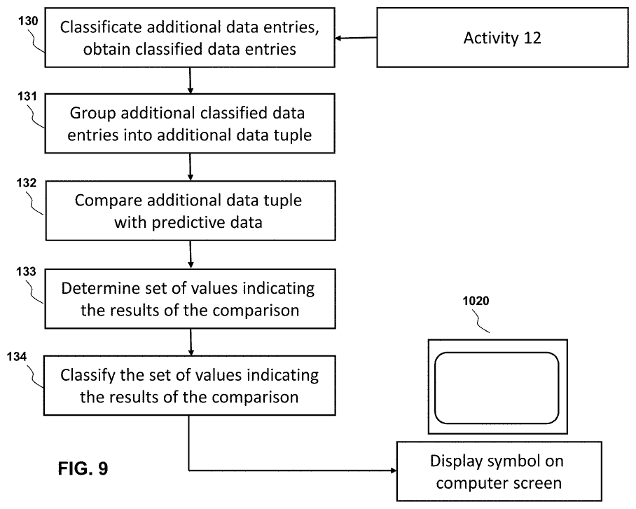

FIG. 9 illustrates activity 13, i.e. the further processing of the additional data together with the predictive data, in more detail. In an activity 130, the additional data entries are classified by computer 1 or one or more of its computing entities according to a first subset of classification criteria, thereby obtaining additional classified data entries. In some embodiment, the first subset of classification criteria may be taken from the sets of classification criteria. In some embodiments, the first subset of classification criteria is the same subset as used in activity 110. The subset may contain classifications such as “invoice number”, “amount to be paid”, “date of invoice”, “VAT”, etc. These classified additional data entries may be, in some embodiment, in a key-value data format. An example for such a classified data entry in a key-value data format taken from the domain of business travel may be <amount to be paid (of hotel costs), 1000 $>. In an activity 131, computer 1 or one or more of its computing entities group the additional classified data entries into additional data tuples according to a second subset of classification criteria, which also may be taken from the sets of classification criteria. In some embodiments, the second subset of classification criteria is the same subset as used in activity 111. The second subset may contain classifications such as “invoice for hotel”, “invoice for dinner”, “invoice for a rental car”, “invoice for fuel at a gas station”. In some further embodiment, a number is attached to the various invoices, such as “invoice number 1”. This number can be combined with a certain business travel of the employee, such as “business travel number 201, employee John Doe”. Such a tuple may then read as follows:

<employee-ID, 999999>;
<employee name, John Doe>,
<business travel number, 201>;
<travel destination country, Canada>,
<city of destination, Ottawa>,
<hotel name, Luxor>,
<number of days, 3>;
<amount of hotel costs, 2000 $>;
etc.

Computer 1 compares in an activity 132 the additional data tuple with the model obtained by the machine learning activity, thereby determining a set of values indicating the results of the comparison. In some embodiment the comparison of the additional data tuple is carried out with the predictive data 13 obtained from the machine learning activity 113 of FIG. 3. As aforementioned, in some embodiment, the predictive data are the usual costs an employee creates during his/her business trips. The usual costs can comprise e.g., the average costs for hotels, meals, flights, rental cars etc. Thereby and shown in FIG. 9, computer 1 determines in an activity 133 a set of values indicating the results of the comparison. The values of the set of values can comprise numerical values calculated as numerical difference between the additional classified data entries, e.g. the travel expenses of the most recent business travel of the employee and the corresponding average value. As an example, the difference may be calculated between the average hotel costs derived from the model and the hotel costs of the most recent business travel. In some embodiments, these differences are included in the basis for the definition of the classification criteria and are included in the input vectors and/or feature vectors.

Subsequently, computer 1 evaluates in an activity 134 the set of values indicating the results of the comparison relative to at least one fraud detection rule, whereby different violations of the fraud detection rule are associated with different corresponding predefined actions. To cite an example, when the difference between the hotel costs of the most recent business trip of the employee and the average hotel costs the employee usually has created so far does not exceed a certain threshold, then no fraud or erroneous input would be assumed. On the other hand, when the difference exceeds a certain threshold, then a potential fraud or erroneous input might occur. In some embodiment, computer 1 executes a predefined action according to the fraud detection rule violation, wherein the predefined action comprises displaying a symbol on a computer screen 1020, as shown in FIG. 9, indicating the level of fraud detection rule violation.

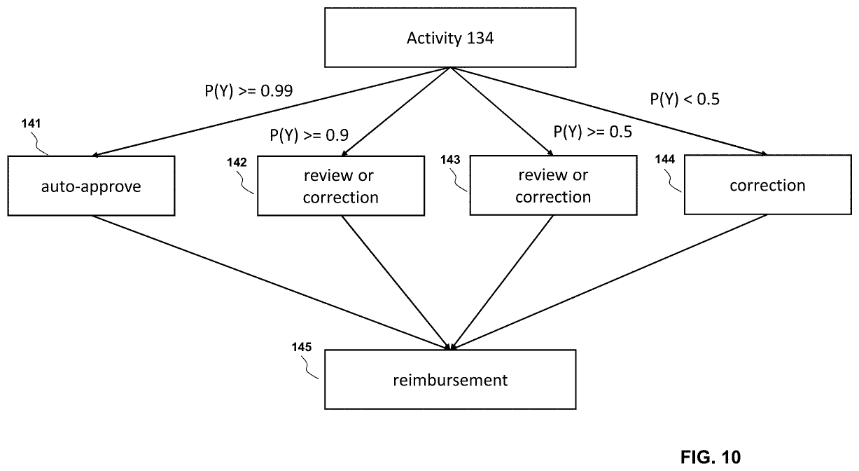

In some embodiment, the levels of fraud detection rule violation are determined based on probabilities that a fraud has occurred and/or on a confidence score, wherein the probability that a fraud has occurred and/or a confidence score are based on a predefined set of confidence thresholds. To cite an example, the chosen confidence thresholds can be formulated as follows (see also FIG. 10):

P(ŷ=1): >=0.99: Auto-approve the reimbursement

>=0.9: Green (slight probability of fraud, needs review by an auditor))

>=0.5: Yellow (higher probability of fraud, needs review by an auditor)

<0.5: Red (fraud seems to occur, requires correction by an auditor)

In this example, three different confidence thresholds are predefined (i.e. 0.99, 0.9, and 0.5). However, the number of predefined thresholds may be larger than three, e.g. four or five confidence thresholds may be predefined. In other examples, the number of predefined thresholds may be smaller than three, e.g. two or only one threshold may be predefined.

The predefined set of confidence thresholds can either be entered by a corporate administrator or auditor together with the supplementary data in activity 30 and be used to define in activity 31 (shown in FIG. 2) a separate, e. g third subset of criteria or the confidence thresholds can be calculated during the machine learning process on the training data, wherein the machine learning activity may also include the additional data entries originating e.g., form most recent business trips of the employee.

In some embodiment and shown in FIG. 10, predefined action includes at least one of approving the classified data entries, attaching a flag to the classified data entries, wherein the flag indicated that the classified data entries are fraudulent. Further citing the aforementioned example, when no fraud or erroneous input is assumed (block 141), the additional travel expenses inputted by the employee will be cleared and the employee gets reimbursed (block 145). On the other hand, if fraud or erroneous input seems probable (blocks 142 and 143), a review by an administrator or auditor of the travel department of the corporation can be introduced. The review by the administrator or auditor may include the modification (block 144) of the additional data entries provided by the employee in order to e.g., correct the fraudulent or erroneous input provided by the employee. The difference between the additional data entries provided by the employee and the modified data entries provided by the administrator or auditor in a feedback may also be included into the training data forming the basis for the machine learning algorithm, as further described in the subsequent paragraphs.

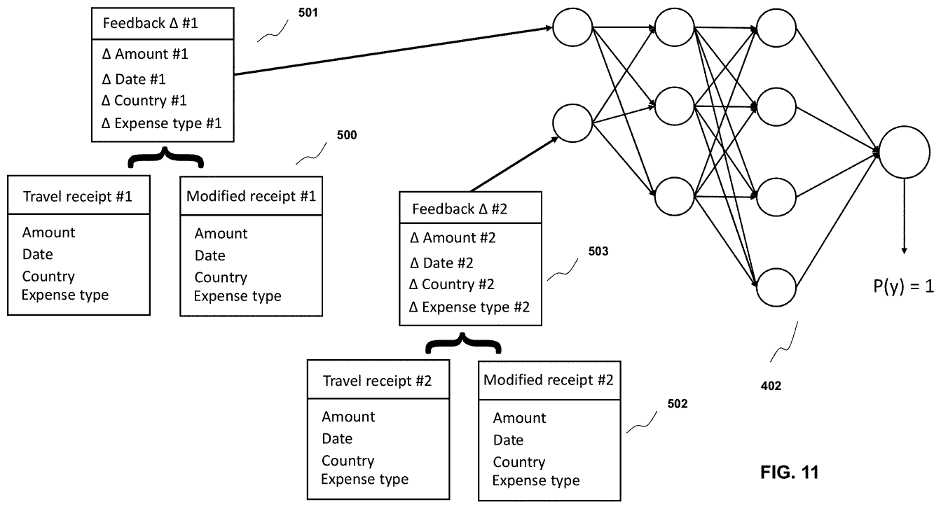

In some embodiment, the training data entries received by the machine learning activity comprise original data entries obtained from scanned documents, as already described in the preceding paragraphs. In some further embodiment, the training data entries further comprise and/or modified data entries provided by a feedback mechanism as feedback training data entries, wherein the feedback mechanism is determined by the classification data, as shown in FIG. 11. In some further embodiment, the modified training data entries comprise feedback training data entries obtained from a plurality of feedback mechanisms.

In FIG. 11, the feedback given on two travel receipts are shown as an example. Travel receipt #1 and travel receipt #2 (generally indicated by reference numerals 500 and 502) needed to be modified, e.g., because of too high expenses for the hotels. Within the modification process, modified receipts #1 and #2 (generally indicated by reference numerals 500 and 502) have been created with lowered expenses for the hotel costs. Hotel expenses for travel receipt #1 may be lowered from $2000 to $1500 and for travel receipt #2 from $2500 to $1800 by an auditor. The numerical differences between the unmodified hotel costs of the original travel receipts #1 and #2 and the modified receipts #1 and #2 may form part of the training data and may be comprised in the feedback training data entries “Feedback A #1” (generally indicated by reference numeral 501) and “Feedback A #2” (generally indicated by reference numeral 503) received by the machine learning system 402, as shown in FIG. 11. This would result e.g., in a regular auditing of new travel receipts of an employee, whose previous travel receipts needed to be modified at several times in the past by an auditor.

In some embodiment, the classification data are obtained using the training data entries. If, as an example, the travel receipts of an employee comprises fares for transports using taxis in a regular scale, a corresponding classification could be added to the classification data. The machine learning system 402 may therefore create a classification <taxi fare> as an example.

FIG. 12 is a diagrammatic representation of the internal component of a computing machine of computer 1 and/or the scanning devices 2 and/or the databases 3. The computing machine 100 includes a set of instructions to cause the computing machine 100 to perform any of the methodologies discussed herein when executed by the computing machine 100. The computing machine 100 includes at least one processor 101, a main memory 106 and a network interface device 103 which communicate with each other via a bus 104. Optionally, the computing machine 100 may further include a static memory 105 and a disk-drive unit. A video display, an alpha-numeric input device and a cursor control device may be provided as examples of user interface 102. The network interface device 103 connects the computing machine 100 to the other components of the distributed computing system such as the computer 1, the scanning devices 2, the databases 3 or further components.

Computing machine 100 also hosts the cache 107. The cache 107 within the present embodiments may be composed of hardware and software components that store the data entries and the machine learning algorithm so that the methodologies or parts of the methodologies discussed herein can carried out. There can be hardware-based caches such as CPU caches, GPU caches, digital signal processors and translation lookaside buffers, as well as software-based caches such as page caches, web caches (Hypertext Transfer Protocol, HTTP, caches) etc. Computer 1, scanning devices 2 and databases 3 may comprise of a cache 107.

A set of computer-executable instructions (i.e., computer program code) embodying any one, or all, of the methodologies described herein, resides completely, or at least partially, in or on a machine-readable medium, e.g., the main memory 106. Main memory 106 hosts computer program code for functional entities such as database request processing 108 which includes the functionality to receive and process database requests and data processing functionality 109. The instructions may further be transmitted or received as a propagated signal via the Internet through the network interface device 103 or via the network interface device 103.

Communication within computing machine is performed via bus 104. Basic operation of the computing machine 100 is controlled by an operating system which is also located in the main memory 106, the at least one processor 101 and/or the static memory 105.

In general, the routines executed to implement the embodiments, whether implemented as part of an operating system or a specific application, component, program, object, module or sequence of instructions, or even a subset thereof, may be referred to herein as “computer program code” or simply “program code”. Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A computer-implemented fraud detection method in a distributed computing environment, the method comprising a machine learning activity and a fraud detection activity, the machine learning activity comprising:
receiving a plurality of training data entries;
receiving classification data and defining a plurality of classification criteria based on the classification data;
classifying the training data entries according to a first subset of classification criteria and thereby obtaining classified training data entries;
grouping the classified training data entries into training data tuples according to a second subset of classification criteria;
grouping training data tuples into a set of training data;
applying a machine learning algorithm to the set of training data to obtain a model based on the set of training data; and
storing the set of training data and/or the model in one or more databases;
and the fraud detection activity comprising:
receiving a plurality of additional data entries obtained from one or more documents;
classifying the additional data entries according to a first subset of classification criteria, thereby obtaining additional classified data entries;
grouping the additional classified data entries into additional data tuples according to a second subset of classification criteria;
comparing the additional data tuple with the model obtained by the machine learning activity, thereby determining a set of values indicating the results of the comparison;
evaluating the set of values indicating the results of the comparison relative to at least one fraud detection rule, wherein different levels of violation of the fraud detection rule are associated with different corresponding predefined actions; and
executing the respective predefined action according to the level of fraud detection rule violation, wherein the predefined action comprises displaying a symbol on a computer screen indicating the level of fraud detection rule violation.

2. The method of claim 1, wherein the machine learning activity further comprises:
calculating differences between corresponding classified training data entries of a first training data tuple and a second training data tuple; and
adding said differences to the set of training data.

3. The method of claim 1, wherein the documents are paper-based documents and scanned by a device for scanning documents, and the additional data entries are extracted from the documents by optical character recognition (OCR) techniques.

4. The method of claim 1, wherein the classified data entries and/or the classified training data entries are arranged as input vectors and/or feature vectors.

5. The method of claim 1, wherein the first subset of classification criteria comprises criteria related to travel expense invoices, and the second subset of classification criteria comprises criteria related to corporate data.

6. The method of claim 1, wherein the levels of fraud detection rule violation are determined based on probabilities that a fraud has occurred and/or on a confidence score, and the probability that a fraud has occurred and/or a confidence score are based on a predefined set of confidence thresholds.

7. The method of claim 1, wherein the predefined action further comprises at least one of approving the classified data entries and attaching a flag to the classified data entries, and wherein the flag indicates that the classified data entries are fraudulent.

8. The method of claim 1, wherein the values comprised by set of values indicating the results of the comparison are calculated as numerical differences between the additional classified data entries of the additional data tuple and the corresponding values of the model obtained by the machine learning activity.

9. The method of claim 1, wherein the training data entries received by the machine learning activity comprise original data entries obtained from scanned documents and/or modified data entries provided by a feedback mechanism as feedback training data entries, and the feedback mechanism is determined by the classification data.

10. A fraud detection system within a distributed computer environment, the fraud detection system comprising:
at least one computing system comprising a machine learning module and a fraud detection module; and
at least one database connected to the at least one computing system;
wherein the machine learning module is configured to:
receive a plurality of training data entries;
receive classification data and define a plurality of classification criteria based on the classification data;
classify the training data entries according to a first subset of classification criteria to obtain classified training data entries;
group the classified training data entries into training data tuples according to a second subset of classification criteria;
group training data tuples into a set of training data;
apply a machine learning algorithm to the set of training data to obtain a model based on the set of training data; and
store the set of training data and/or the model in one or more databases;
and wherein the fraud detection module is configured to:
receive a plurality of additional data entries obtained from one or more documents;
classify the additional data entries according to a first subset of classification criteria to obtain additional classified data entries;
group the additional classified data entries into additional data tuples according to a second subset of classification criteria;
compare the additional data tuple with the model obtained by the machine learning activity to determine a set of values indicating the results of the comparison;
evaluate the set of values indicating the results of the comparison relative to at least one fraud detection rule, wherein different levels of violation of the fraud detection rule are associated with different corresponding predefined actions; and
execute the respective predefined action according to the level of fraud detection rule violation, wherein the predefined action comprises displaying a symbol on a computer screen indicating the level of fraud detection rule violation.

11. The fraud detection system of claim 10, wherein the machine learning module is further configured to:
calculate differences between corresponding classified training data entries of a first training data tuple and a second training data tuple; and
add said differences to the set of training data.

12. The fraud detection system of claim 10, wherein the fraud detection system further comprises a device for scanning documents, the documents are paper-based documents and scanned by the device for scanning documents, and the additional data entries are extracted from the documents by optical character recognition (OCR) techniques.

13. The fraud detection system of claim 10, wherein the classified data entries and/or the classified training data entries are arranged as input vectors and/or feature vectors.

14. The fraud detection system of claim 10, wherein the first subset of classification criteria comprises criteria related to travel expense invoices, and the second subset of classification criteria comprises criteria related to corporate data.

15. The fraud detection system of claim 10, wherein the levels of fraud detection rule violation are determined based on probabilities that a fraud has occurred and/or on a confidence score, and wherein the probability that a fraud has occurred and/or a confidence score are based on a predefined set of confidence thresholds.

16. The fraud detection system of claim 10, wherein the predefined action further comprises at least one of approving the classified data entries and attaching a flag to the classified data entries, wherein the flag indicates that the classified data entries are fraudulent.

17. The fraud detection system of claim 10, wherein the values comprised by set of values indicating the results of the comparison are calculated as numerical differences between the additional classified data entries of the additional data tuple and the corresponding values of the model obtained by the machine learning activity.

18. The fraud detection system of claim 10, wherein the training data entries received by the machine learning module comprise original data entries obtained from scanned documents and/or modified data entries provided by a feedback mechanism as feedback training data entries, and wherein the feedback mechanism is determined by the classification data.

19. The fraud detection system of claim 28, wherein the modified training data entries comprise feedback training data entries obtained from a plurality of feedback mechanisms, and the classification data are obtained using the training data entries.

20. A non-transitory computer-readable medium comprising computer-readable instructions that upon execution by a processor of a computing device cause the computing device to execute a machine learning activity and a fraud detection activity,
wherein the machine learning activity comprises:
receiving classification data and defining a plurality of classification criteria based on the classification data;
classifying a plurality of training data entries according to a first subset of classification criteria and thereby obtaining classified training data entries;
grouping the classified training data entries into training data tuples according to a second subset of classification criteria;
grouping training data tuples into a set of training data;
applying a machine learning algorithm to the set of training data to obtain a model based on the set of training data; and
storing the set of training data and/or the model in one or more databases;
and wherein the fraud detection activity comprises:
receiving a plurality of additional data entries obtained from one or more documents;
classifying the additional data entries according to a first subset of classification criteria, thereby obtaining additional classified data entries;
grouping the additional classified data entries into additional data tuples according to a second subset of classification criteria;
comparing the additional data tuple with the model obtained by the machine learning activity, thereby determining a set of values indicating the results of the comparison;
evaluating the set of values indicating the results of the comparison relative to at least one fraud detection rule, wherein different levels of violation of the fraud detection rule are associated with different corresponding predefined actions; and
executing the respective predefined action according to the level of fraud detection rule violation, wherein the predefined action comprises displaying a symbol on a computer screen indicating the level of fraud detection rule violation.
